(19) United States
(12) Patent Application Publication
(10) Pub. No.: US 2013/0093293 A1
(43) Pub. Date: Apr. 18, 2013

(54) Hybrid electric motor

(71) Applicant: Brett Price, Monroe, OH (US)

(72) Inventor: Brett Price, Monroe, OH (US)

(21) Appl. No.: 12/799,522

(22) Filed: Apr. 27, 2010

(51) Int. Cl. H02K 11/00

(52) U.S. Cl. CPC H02K 11/0021; H02K 11/0026
USPC 310/68 B

(57) ABSTRACT

The invention is an efficient electric motor which has fixed permanent and electromagnets in the stator with fixed permanent magnets in the rotor. An electronic Pulse Width Modulator (PWM) controller manages the flow of electric power to the electromagnets of the stator. Infrared sensors and Hall sensors provide the controller with the precise location of the rotor thus allowing the controller to provide the maximal electromagnetic forces to provide increased efficiency for the present electric motor. The present inventive motor is useful in an electric automobile or household use.

### BACKGROUND OF INVENTION

1. Field of Invention

The present invention is concerned about improved permanent magnet electric motors. Electric motors operate on the principle of magnetic attraction and repulsion forces. Thus in any electric motor that motor rotates when positive magnetic fields of the rotor are forced apart with positive magnetic fields of the stator and negative magnetic fields of the rotor are forced apart by the negative magnetic fields of the stator. The rotor is that part of an electric motor which rotates. The stator is a stationary part of the electric motor. The present invention is the field of a combination of permanent magnet electromagnetic motors.

2. Background of Invention

Elements of an electric motor consists of magnetic fields which magnetic fields constantly change, and which magnetic fields constantly attract and repulse each other. The power efficiency of an electric motor comprises of the strength and quantity of the permanent magnets, electromagnetic excitation field resulting in a high strength rotating magnetic flux linkage while keeping minimal heat losses in the iron laminations both in the stator and rotor parts. Other elements include the total rotor mass and its maintained inertia keeping friction minimal by means of greased roller bearings about a centered shaft harnessing the rotor velocity and torque as usable kinetic energy to perform work in horse power ratings.

As the rotor turns the magnetic field constantly changes, and a small distances can change relatively rapidly. Thus, the present invention combines maximum magnetic field with the changes in magnetic field constantly maintained in a high-level by an outer electronic control that constantly changes variable magnetic excitation fields to provide the maximum attraction and repulsion forces with minimal drop in the resulting magnetic flux linkage. This is achieved by a sustained and rapid release of potential energy expelled from a controlled plurality of high energy magnets along their specified load line as strategically located about the invention, both are used to develop a rotating force field of magnetic energy that is mechanically translated into a sustained kinetic energy in the rotor while it may be under a heavy or minimal external load condition.

This invention has been computer analyzed in its materials and electronic circuits used in producing specific amounts of rotor velocity and torque from determined magnetic circuit positions which give the best desired results when coupled mechanically to any of several auxiliary subsystems being described in detail below.

The inventive aspect of the present invention concerns a method of maintaining maximal electromagnetic repulsion or attraction throughout the cycle of rotation of the motor. The Figures will teach how to construct the improved electrical motor. Any number of fasteners or industrial adhesives may be used in the assembly process being described.

### SUMMARY OF INVENTION

The invention is an efficient electric motor which has fixed permanent and electromagnets in the stator with fixed permanent magnets in the rotor. An electronic Pulse Width Modulator (PWM) controller manages the flow of electric power to the electromagnets of the stator. Infrared sensors and Hall sensors provide the controller with the precise location of the rotor thus allowing the controller to provide the maximal electromagnetic forces to provide increased efficiency for the present electric motor. The present inventive motor is useful in an electric automobile or household use.

### BRIEF DESCRIPTION OF FIGURES

FIG. 1 shows expanded rotor assembly 1 of the improved motor.

FIG. 2 shows the expanded core assembly of the stator 2.

FIG. 3 shows assembled stator 2.

FIG. 4 shows drive shaft 1E which is affixed with the Cordal spline 225 to Cordal splined central opening 224 of aluminum hub 1c with a first shoulder washier 1m and bolt.

FIG. 5 shows the details of detect and feedback controls that allow the increased efficiencies of the present invention.

FIG. 6 shows a schematic diagram of the connected systems of the present invention.

FIG. 7 shows that to start the motor, rotor 2 must be rotated from the state of neutral magnetic flux.

FIG. 8 shows targeted un-commutated maximal magnetic field circuit alignment of rotor 1 to stator 2.

FIG. 9 is a more complete parts key to assist understanding of the invention.

FIG. 10 show the three views of the invention.

FIG. 11 shows uses of invention with alternator regulator 8 as intended for more efficient automobile propulsion and option 2, connected generator for household use for CO₂ reduction.

FIG. 12 shows BCD codes generated by Hall magnets 5b in rotation.

### DETAILED DESCRIPTION OF INVENTION

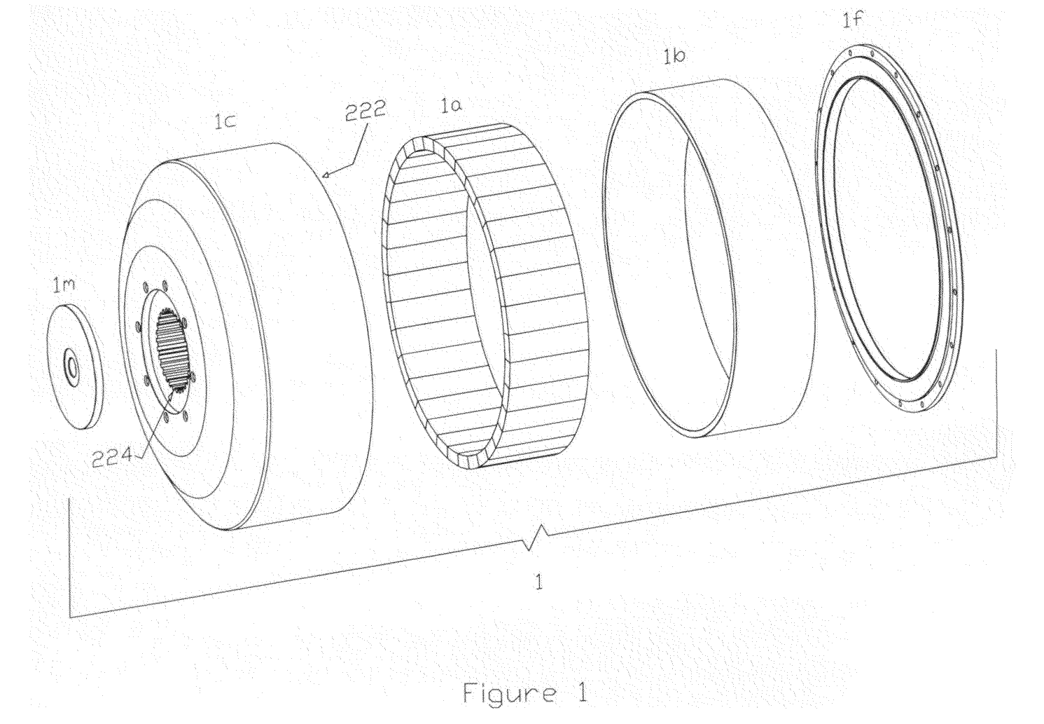

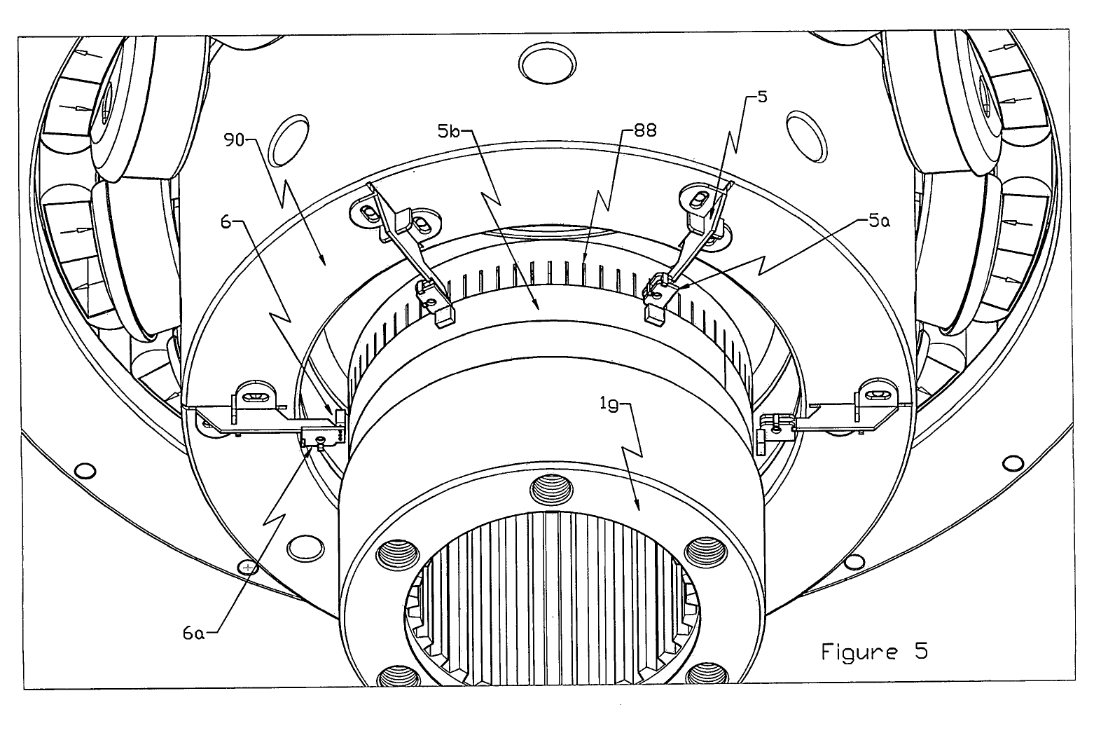

FIG. 1 shows expanded rotor assembly 1 of the improved motor. Rotor magnets of the present invention, optimally neodymium iron boron (NdFeB) magnets hereafter NdFeB magnets 1a are shown as a gathered ring 1a. Optimally, the number of magnets is 36. The free independent magnets of 1a are held as an array of magnets within laminated steel sheets 1b. Laminated steel sheets 1b with magnets are placed within cavity 222 of aluminum hub 1C. Note, aluminum hub 1C has Cordal splined central opening 224 for drive shaft 1e. (Cordal splined is one of any number of drive shaft attachment means. (Drive shaft 1e is shown in FIG. 4.) Retainer ring 1F securely holds the assembly together.

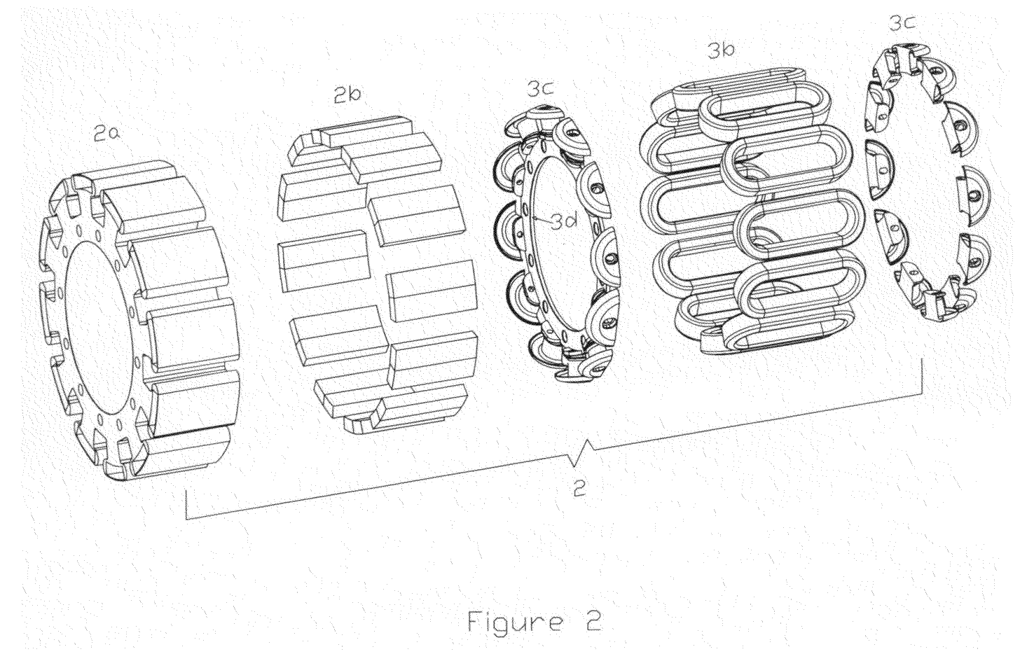

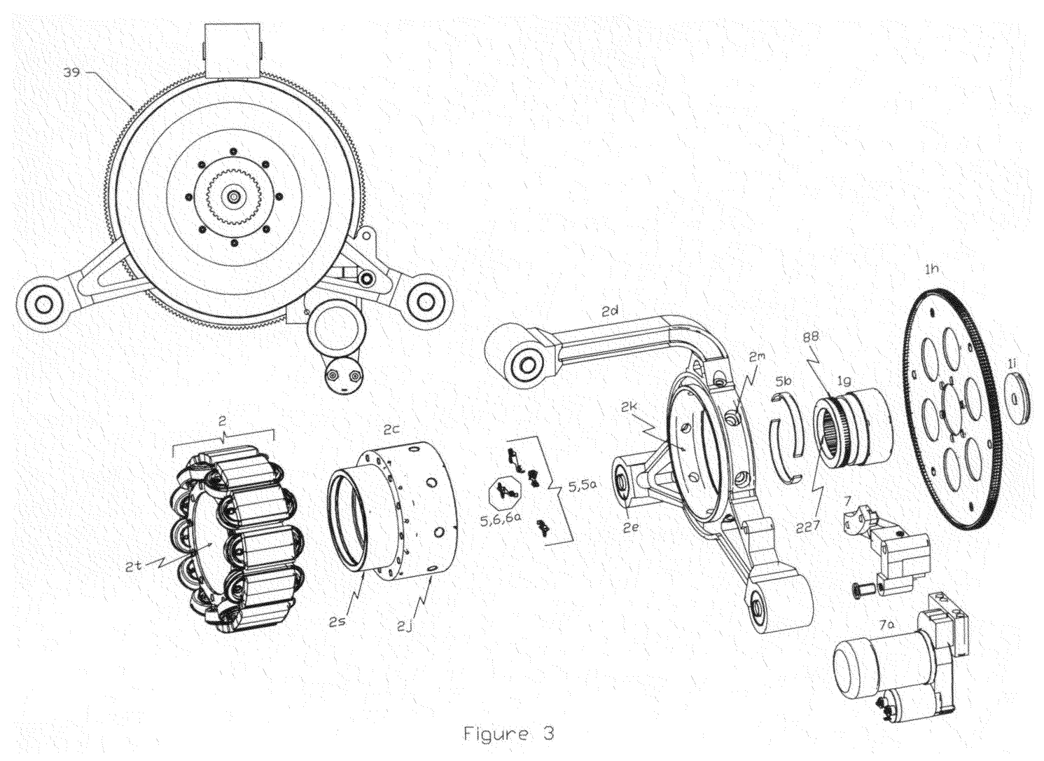

FIG. 2 shows the expanded core assembly of the stator 2. Laminated steel sheets 2a are the framework of the stator. A total of 24 NdFeB magnets are shown as 2b. Stator assembly has NdFeB magnets affixed (pressed) within laminated steel sheets 2a.

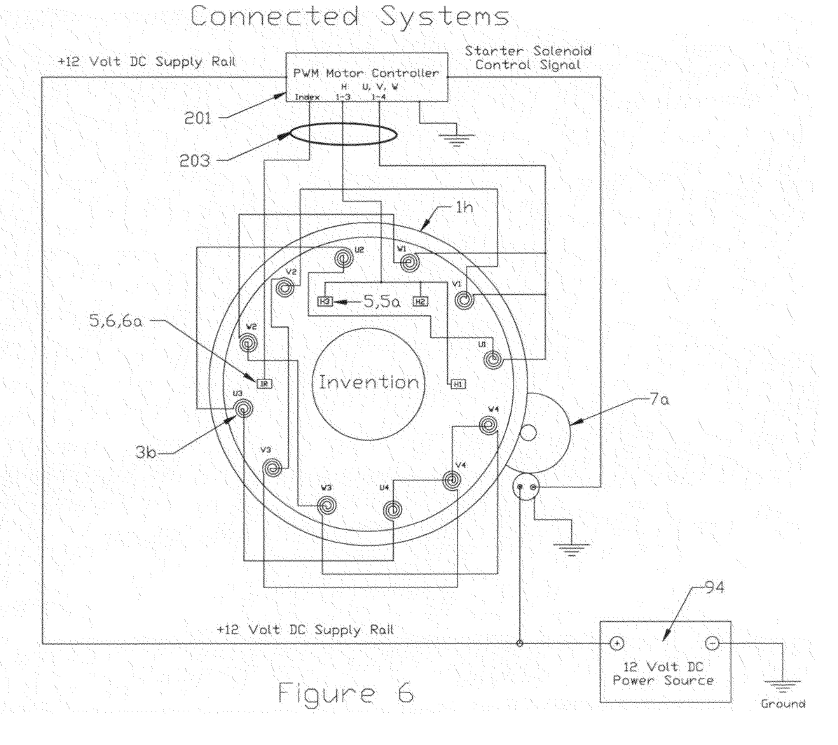

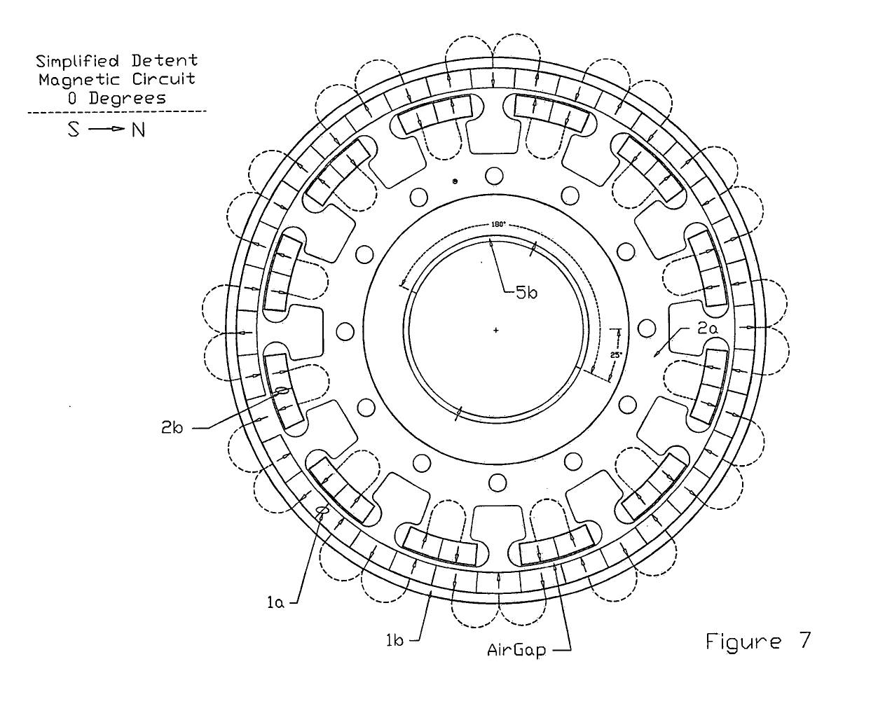

Coils 3b are directly wired 203 to controller 201 (shown diagrammatically in FIG. 6) PWN to receive electricity from that controller. The stator assembly FIG. 2 is used to control the rotation induced into the outer complement of 36 magnets of the rotor assembly 1. Coil blocks 3c hold the coils 3b stationary within the laminated steel sheets 2a.

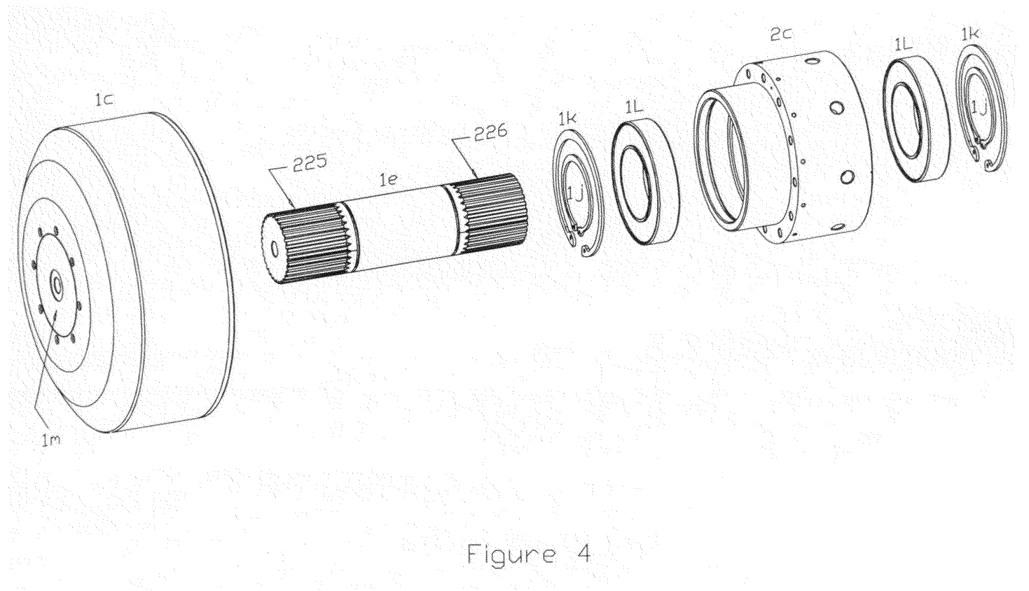

FIG. 3 shows assembled stator 2. Typically, a stator does not move. Assembled stator 2 is affixed bearing base 2c on extended rim 2s with affixing means such as bolts (not shown). The mounting means is bearing base 2c. Bearing base 2c has holes 2j. Bolts join and affix bearing base 2c holes 2j to mounting core opening 2k holes 2m. Bearing base 2c has extended rim 2s which fits into hollow 2t of assembled magnet part 2 of stator.

Other aspects of the improved invention are shown in FIG. 3. Starter bracket 7 receives high torque automotive starter 7a. Flex plate 1h (14″ Ring Gear) is rotated by starter 7a. The assembled invention is shown as front view 39.

By definition, a motor requires a rotor to spin relative to a stator. FIG. 4 shows drive shaft 1E which is affixed with the Cordal spline 225 to Cordal splined central opening 224 of aluminum hub 1c with a first shoulder washier 1m and bolt. (Opposite Cordal splined end 226 is placed within shaft coupler 1g opening 227 (FIG. 3) and is held in place by a second shoulder washer 1i and bolt to shaft 1e. (FIG. 1 shows expanded internal components of the rotor of the present invention.) (FIG. 3 shows bearing mount 2c to be affixed to motor hanger bracket 2d.) Returning to FIG. 4 bearings (Sealed) 1L are held in place within bearing base 2c by snap rings 1k where shaft 1e is center set in bearings 1L and held fixed by snap rings 1j.

FIG. 5 shows the details of detect and feedback controls that allow the increased efficiencies of the present invention. Shaft coupler 1g has slots 88 each 0.025″ wide spaced at 5 degrees apart for a total 72. Infrared reflective sensor 6 FIG. 5 is used to generate index pulses every 5 degrees of rotor movement. Infrared reflective sensor 6 send and receive pulses which mixes the index and tachometer pulse stream and is used to determine initial rotor commutation start angles of 55 plus or minus 1 degree, 255 plus or minus 1 degree, and 355 plus or minus 1 degree. In operating slots 88 with reflective sensor 6 become a tachometer of rotor RPM when coupled to a micro controller 201 in increased efficiency motor. Sensor arms 5 are attached to flange face 90. Both reflective sensors 6 and Hall sensors are mounted on sensor arm 5.

The 3 Hall sensors 5a act in combination with Hall magnets 5b. The assembled combination of a Hall sensor, bypass capacitor and lead wire connections are affixed by screws and are mounted at 60 degree positions on the flange face 90 with screws. Hall magnets 5b each is a 180 degree arc secured to the shaft coupler 1g. The ends of both magnet arcs 5b are installed at minus 25 degrees in the groves provided on the shaft coupler 1g.

FIG. 6 shows a schematic diagram of the connected systems of the present invention. Schematic box 201 is a 3 phase PWM (pulse width modulated) motor controller such as the Luminary □ micro LM3 S 8971 BLDC motor control RDK heretofore and hereafter called controller 201. Electric current to rotate the present invention is controlled by controller 201 through connecting wires 203 to the 12 phase coils 3b. (Shown in FIG. 2.) Note, FIG. 2 does not show the connecting wires 203.

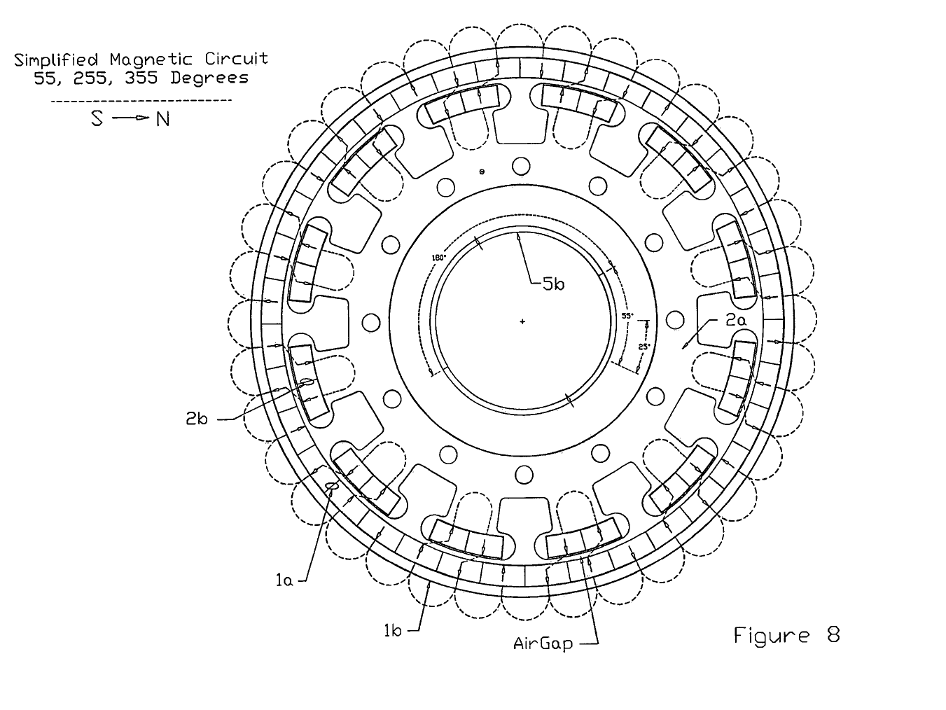

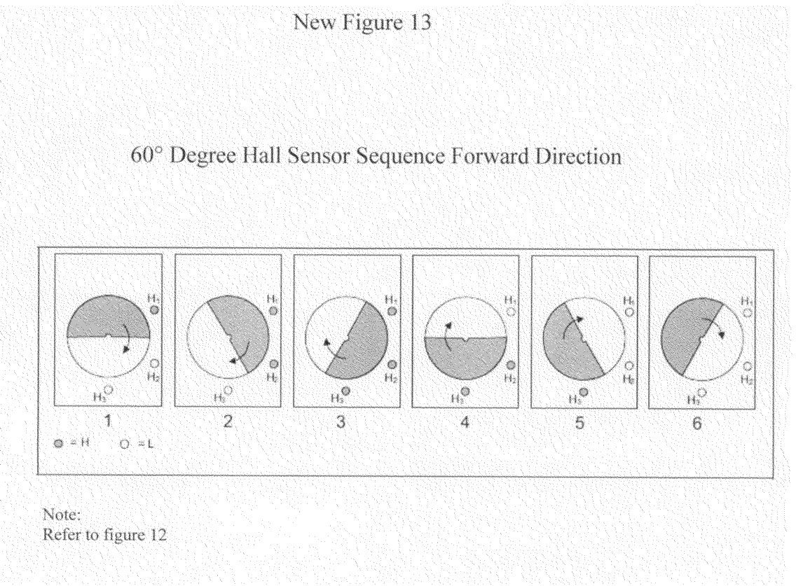

To start the motor, rotor 2 must be rotated from the state of neutral magnetic flux seen in FIG. 7. Note, neutral magnetic flux is considered point 0 or detent. Power for startup rotation described below is from power source (battery) 94. Standard programmable three phase motor controller 201 engages and disengages starter 7A at specified degrees. Targeted un-commutated maximal magnetic field circuit alignment of rotor 1 to stator 2 is achieved at 55, 255, or 355 each plus or minus 1 degree (shown in FIG. 8) which will cause maximum torque onto shaft 1e. This rotation degree change from starting point zero to 55, 255, or 355 is directed from controller 201 to starter 7a. (See FIG. 3) Starter 7a engages geared flex plate 7h to move to the 55, 255, or 355 degrees wherein the motor immediately disengages. Controller 201 would then begin commutation of the 12 phase coils 3b while rotor position is detected by three Hall sensors 5a generating six BCD codes in controller 201 as shown in FIG. 12 every 60 degrees of rotor displacement.

Controller 201 receives the precise degree of rotation from monitoring infrared sensors 6 and 6a. There is also an index pulse signal generated every 5 degrees of rotor displacement by a reflective infrared sensor detecting 0.025″ slots 88 in the shaft coupler 1g shown in FIG. 5. Infrared sensor 6 works in combination with Hall sensors coordinated by comptroller 201.

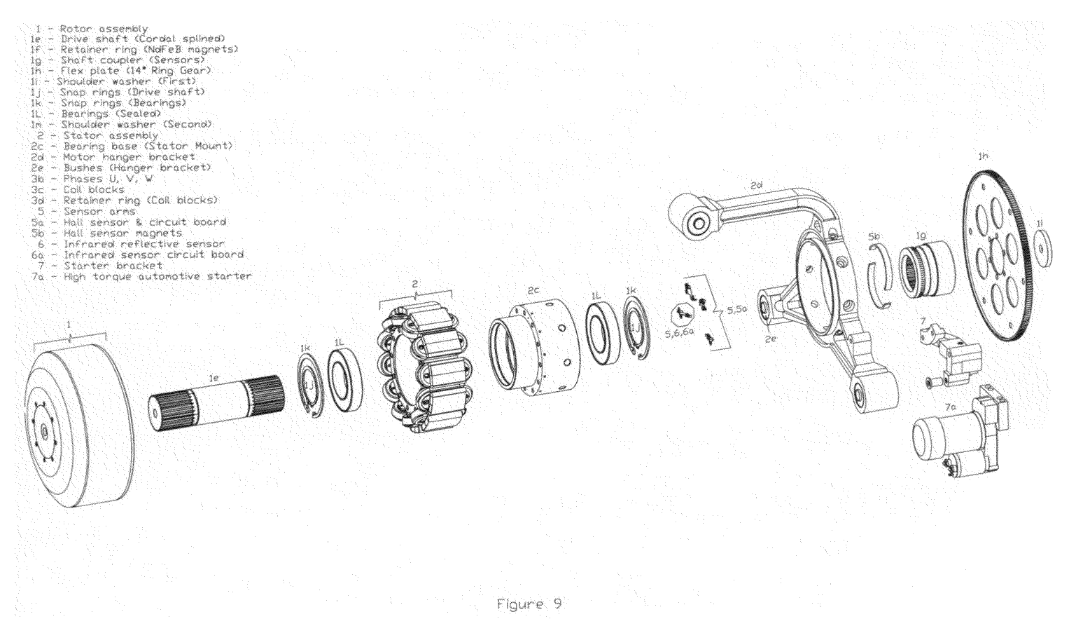

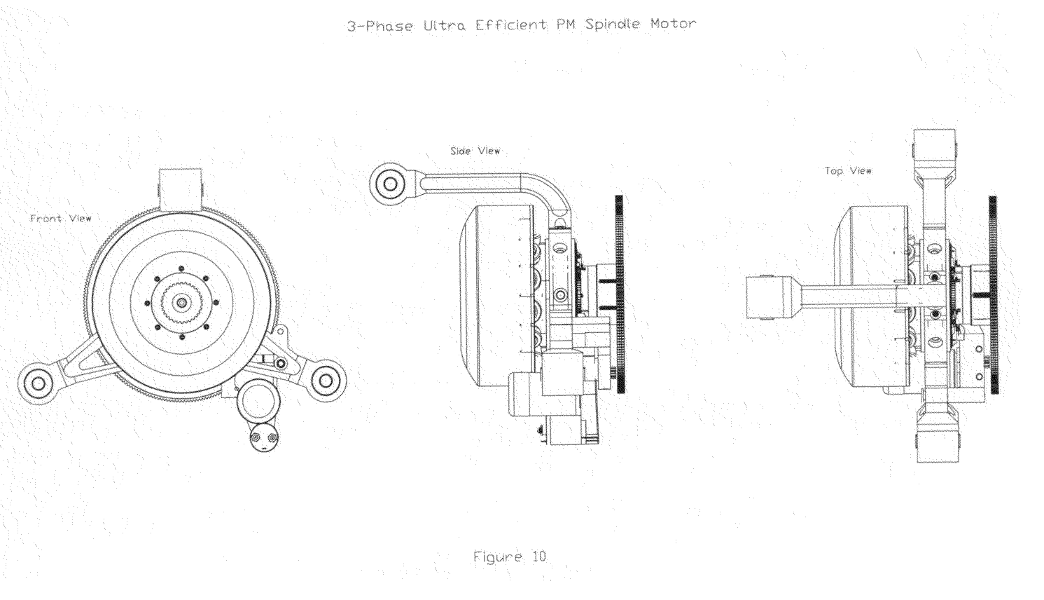

FIG. 9 is a more complete parts key to assist understanding of the invention.

FIG. 10 show the three views of the invention.

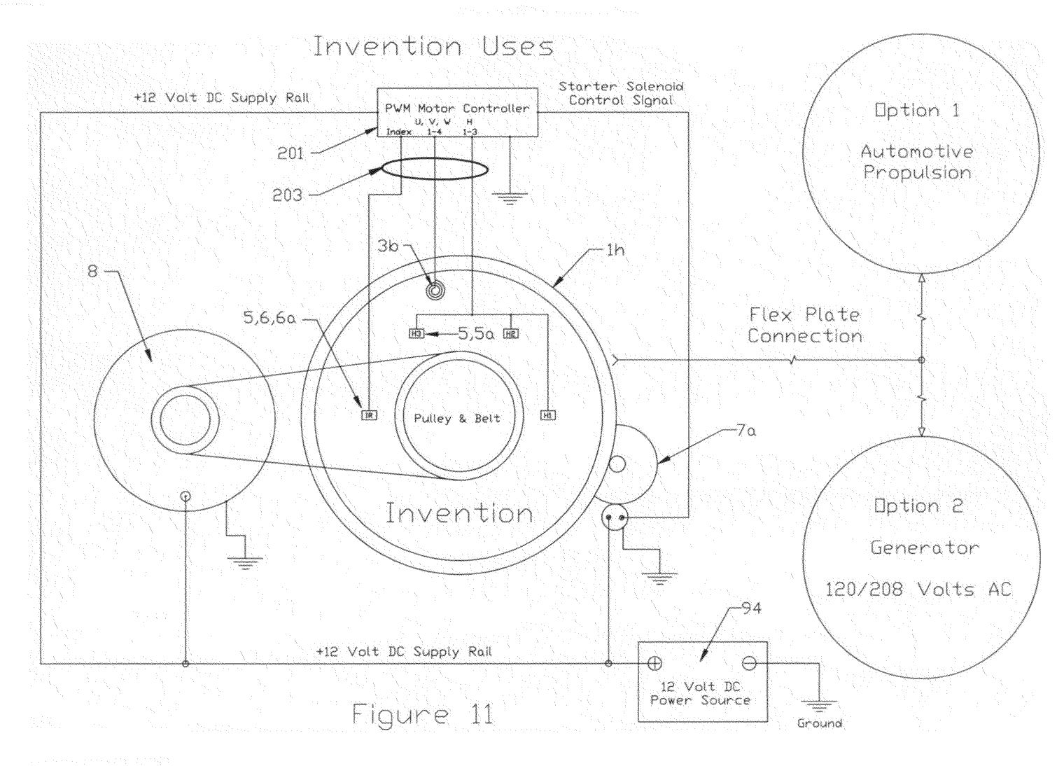

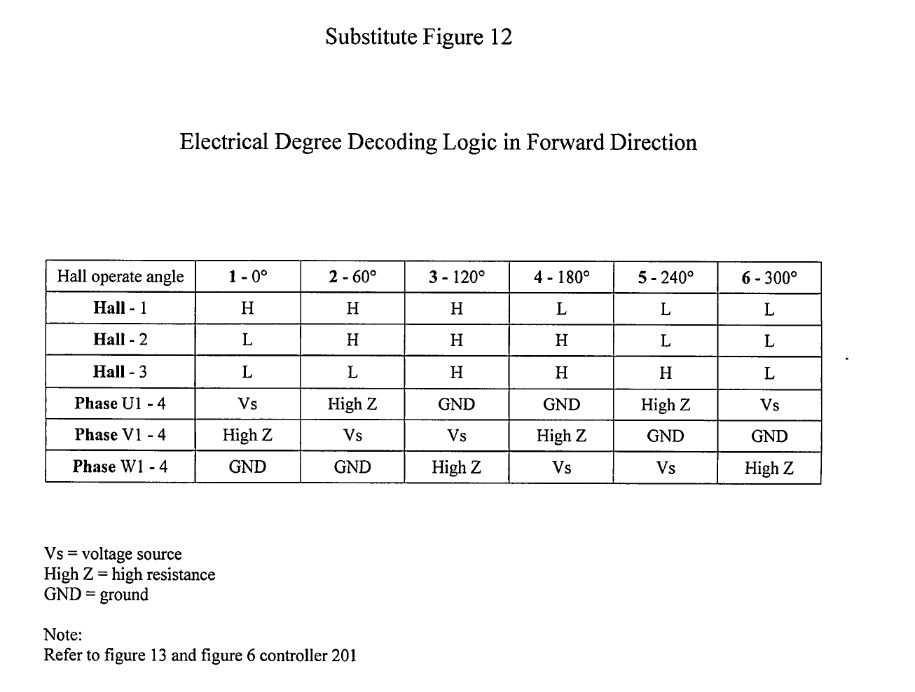

FIG. 11 shows uses of invention with alternator regulator 8 as intended for more efficient automobile propulsion and option 2, connected generator for household use for CO₂ reduction.

FIG. 12 shows BCD codes generated by Hall magnets 5b in rotation.

I claim:

1. an electric motor comprising:
a) a controller 201
b) motor hanger (bracket) 2d;
c) bearing base 2c;
c) a stator assembly 2;
d) a rotor assembly 1;
e) a drive shaft 1e;
f) Hall sensors 5a in combination with Hall magnets 5b;
g) reflective sensor 6 in combination with slots 88 on shaft coupler 1g;
h) starter 7a;
i) a power source 94;
said bearing base 2c has a means to affix said stator assembly 2;
said stator assembly has NdFeB magnets affixed within laminated steel sheets;
said stator coils 3b are connected with electric wires 203 to said controller 201;
said coils 3b are held in place by coil blocks 3c attached to stator 2a;
said rotor assembly 1 has aluminum hub 1c;
said aluminum hub 1c has a Cordal splined central opening 224 for drive shaft 1e, and cavity 222;
within said cavity 222 is affixed a laminated iron sheets in a ring 1b with internally affixed NdFeB magnets 1a held in place with a retainer ring 1f;
said rotor assembly 1 is affixed on drive shaft 1e with shoulder washer 1i;
said internal shaft rotates within bearings 1l are affixed within said bearing base 2c;
bearing base 2c is affixed to mounting core opening 2k. of motor hanger bracket 2d;
said controller 201 activates starter 7a with electricity from said power source;
said starter 7a engages geared flex plate 1h to rotate said rotor from zero degrees to either 55, 255, or 355 plus or minus 1 degree wherein the starter 7a immediately disengages;
said controller 201 receives an index pulse signal from infrared sensor 6 generated every 5 degrees of rotor displacement from slots 88 in the shaft coupler 1g reflected to monitoring infrared sensors 6 and 6a;
said infrared sensor is mounted on sensor arm 5;
said sensor arms 5 are attached to flange face 90;
said controller 201 receives input from Hall sensors 5a in combination with Hall magnets 5b;
said Hall sensors 5a are affixed to sensor arm 5;
said Hall magnets 5b are affixed to shaft coupler 1g;
said controller 201 provides variable amounts of electric current with electric wire to coils 3b;
said variable PWM electric current provides efficient motor rotation;
said power source powers said starter motor 7a and powers invention via controller 201;
said starter motor 7a is mounted on motor mount 2d by starter bracket 7 affixed to bearing base 2c.
